(19) United States
(12) Patent Application Publication
(10) Pub. No.: US 2007/0056446 A1
(43) Pub. Date: Mar. 15, 2007

(54) Self cleaning filter assembly and circulation system

(76) Inventor: Kim Lui So, Singapore (SG)

Correspondence Address: Loren G. Helmreich;Browning Bushman P.C., 5718 Westheimer, Suite 1800, Houston, TX, 77057, US

(21) Appl. No.: 10/573,431

(22) PCT Filed: Dec. 21, 2004
(86) PCT No.: PCT/SG04/00424

§ 371 Date: Mar. 24, 2006

(30) Foreign Application Priority Data
Feb. 13, 2004 (SG) 200400668-0

(51) Int. Cl. B01D 46/04

(52) U.S. Cl. 96/233

(57) ABSTRACT

There is provided a self cleaning filter assembly for use in an exhaust system, including: a casing for placement in the path of an air flow, the casing containing: a first filter; a second filter; a barrier for placement adjacent to the casing to prevent a cleaning fluid from dripping from the first filter and out from the casing; and a plurality of spray outlets for dispersion of fluid within the casing and onto the filters. The plurality of spray outlets create droplets of the cleaning fluid of a size able to combine with droplets of a contaminant to form combined droplets in the air flow and wherein the first filter and the second filter captures droplets of the contaminant and droplets from the spray outlets. A circulation system for use with the filter assembly is also disclosed.

### FIELD OF THE INVENTION

The present invention relates to a self-cleaning filter assembly and refers particularly, though not exclusively, to a self-cleaning filter assembly for use in domestic and industrial exhaust systems for exhausting vapours such as, for example, vapours produced by cooking in kitchens and chemical processes.

### BACKGROUND TO THE INVENTION

It is mandatory in many industries to employ exhaust systems for removing contaminated air from affected work areas. Examples of such industries are the manufacturing and chemical industries.

Such exhaust systems are commonly employed in kitchens such as industrial and commercial kitchens in the food processing industry, and restaurants. Whenever food is cooked, it is common for the food to be cooked using oil. As such, cooking creates fumes which contain oil droplets.

Filters that are installed within such exhaust systems usually comprise a steel mesh to capture the majority of oil droplets. Such filters may be located in the exhaust hood, the flue of the exhaust hood, or in the ducting. Droplets which are not captured by the filter may end up coating the internal surfaces of the exhaust hood, the flue, and the ducting. When these oil droplets cool and start to dry they become very sticky, and are hard to remove. Some of these droplets that do not coat the internal walls of the exhaust system may be expelled into the atmosphere, contributing to air pollution. Other problems that may arise are: shortened exhaust fan life span due to clogging by contaminants, a rapid build-up of bacteria in the internal walls of the exhaust system leading to a compromise of hygiene; increased fire risk from a dried grease layer along the internal walls; and workplace ventilation problems resulting from ineffective exhaust operation.

The filters employed in such exhaust systems have fairly open mesh patterns as having too fine a mesh pattern would cause each filter to be easily clogged, leading to minimised system effectiveness, and increase in system downtime due to frequent filter maintenance and cleaning. Such maintenance sessions are time-consuming, tedious, and labour intensive task. As such, it is usually not a cheap process.

There have been many proposals for self cleaning exhaust systems using water curtains, water baths, or sprays. However, most are one or more of: complex, large, expensive, ineffective, dangerous to use.

### SUMMARY OF THE INVENTION

There is provided a self cleaning filter assembly for use in an exhaust system, including: a casing for placement in the path of an air flow, the casing containing: a first filter; a second filter; a barrier for placement adjacent to the casing to prevent a cleaning fluid from dripping from the first filter and out from the casing; and a plurality of spray outlets for dispersion of fluid within the casing and onto the filters. The plurality of spray outlets create droplets of the cleaning fluid of a size able to combine with droplets of a contaminant to form combined droplets in the air flow and wherein the first filter and the second filter captures droplets of the contaminant and droplets from the spray outlets.

The barrier may be a plurality of louvres that creates openings when the exhaust system is operational. The plurality of louvres may be fixed in a particular orientation. Alternatively, the barrier is slidable into the casing to create an opening when the exhaust system is operational.

Advantageously, the barrier includes baffles to retard the air flow. Preferably, the barrier includes at least one chamber for the containment of fluid. It is preferable that there is a conduit for fluid drainage in the at least one chamber.

It is preferable that each spray outlet disperses fluid with an arc of between sixty degrees and one hundred eighty degrees. It is more preferable that each spray outlet disperses fluid with an arc of ninety degrees. It is desirable for each spray outlet to be a nozzle.

Preferably, the cleaning fluid includes water and a degreaser in a required ratio in the range 1:10 to 1:50. The plurality of spray outlets may be on an inlet side of a filter selected from the group consisting of the first filter and the second filter. The plurality of spray outlets may be located at each edge of a filter selected from the group consisting of the first filter and the second filter. The plurality of spray outlets may be located at the middle portion of each side of a filter selected from the group consisting of the first filter and the second filter. The plurality of spray outlets may also be located on opposed comers of a filter selected from the group consisting of the first filter and the second filter.

It is preferable that the plurality of spray outlets are located within the casing. It is advantageous that the barrier comprises at least one chamber with at least one baffle therein.

There is also provided a circulation system for fluids into at least one self cleaning filter assembly including: a circulation tank; and a circulation pump. Preferably, the circulation pump operates as a venturi pump to circulate fluids in the system. It is advantageous that there is at least one valve to control the flow of water into the circulation tank. There may also be a supplementary tank for the containment of a fluid constituant. A dispenser for the fluid constituant may also be included. The fluid constituant is preferably degreaser. It is preferable that the fluid is cleaning solution and the ratio of degreaser to water may be in the range of 1:10 to 1:50. It is most preferable that the ratio of degreaser to water is 1:20. A stream of air may preferably be introduced into the fluids in the system either before or after the circulation pump.

### DESCRIPTION OF THE DRAWINGS

In order that the invention can be readily understood and put into practical effect, there shall now be described by way of non-limitative example only a preferred embodiment of the present invention, the description being with reference to the accompanying illustrative drawings in which:

FIG. 1 shows a side view of the self deaning filter assembly of a preferred embodiment of the present invention with louvres at an “open” position;

FIG. 2 shows a side view of an alternative embodiment of the self cleaning filter assembly of the present invention with louvres at an “open” position.

FIG. 3 shows the front view of the nozzle arrangement in FIG. 1;

FIG. 4 shows a front view of a second filter of the self deaning filter assembly of the present invention with a second arrangement of spray outlets;

FIG. 5 shows a front view of a second filter of the self cleaning filter assembly of the present invention with a third arrangement of spray outlets;

FIG. 6 shows a front view of a second filter of the self cleaning filter assembly of the present invention with a fourth arrangement of spray outlets;

FIG. 7 shows a side view of the self cleaning filter assembly of the present invention employed in an exhaust system;

FIG. 8 shows the front view of the nozzle arrangement in FIG. 2;

FIG. 9 shows a front view of a first filter of the self cleaning filter assembly of the alternative embodiment of the present invention with a second arrangement of spray outlets;

FIG. 10 shows a front view of a first filter of the self cleaning filter assembly of the alternative embodiment of the present invention with a third arrangement of spray outlets;

FIG. 11 shows a front view of a first filter of the self cleaning filter assembly of the alternative embodiment of the present invention with a fourth arrangement of spray outlets;

FIG. 12 shows a side view of the self cleaning filter assembly of the alternative embodiment of the present invention employed in an exhaust system;

FIG. 13 shows a side view of the self cleaning filter assembly of the present invention with louvres at an “close” position;

FIG. 14 shows a preferred embodiment of the present invention employed into an existing exhaust hood system;

FIG. 15 shows a close up view of the edges of louvres in a fixed orientation in an alternative embodiment of the self cleaning filter assembly;

FIG. 16 shows a system to circulate cleaning solution in an exhaust hood system; and

FIG. 17 shows a flow chart for the operation of a system to circulate cleaning solution in an exhaust hood system.

### DESCRIPTION OF THE PREFERRED EMBODIMENTS

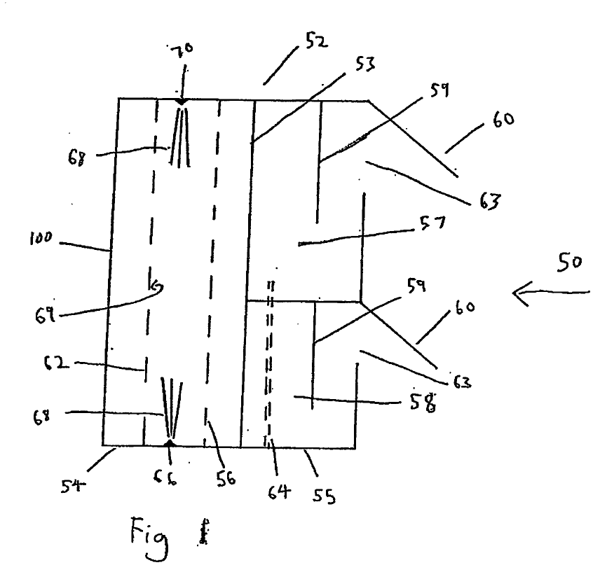

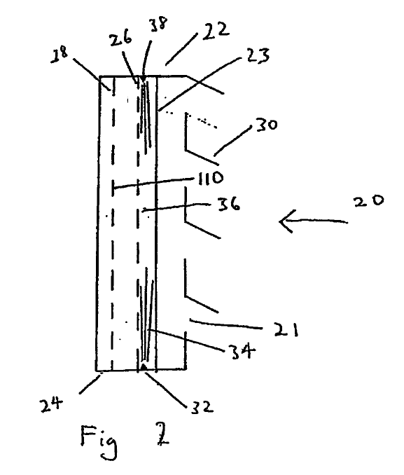

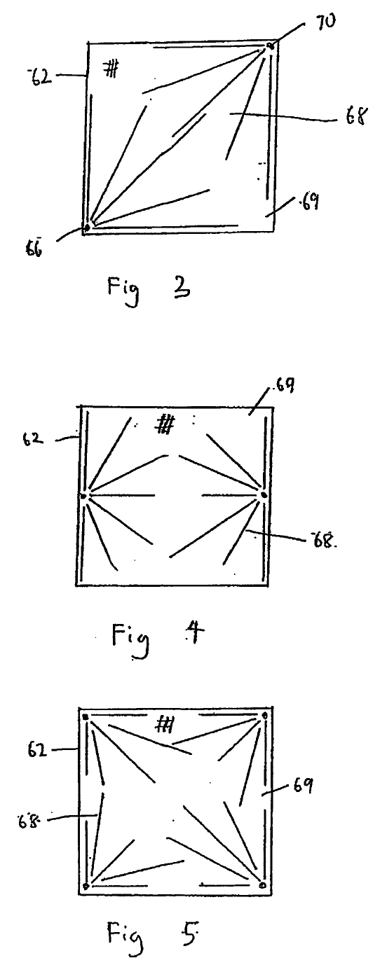

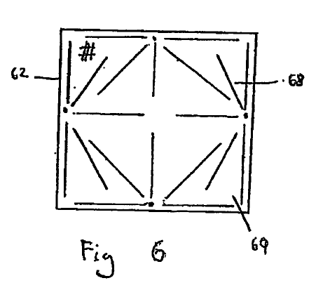

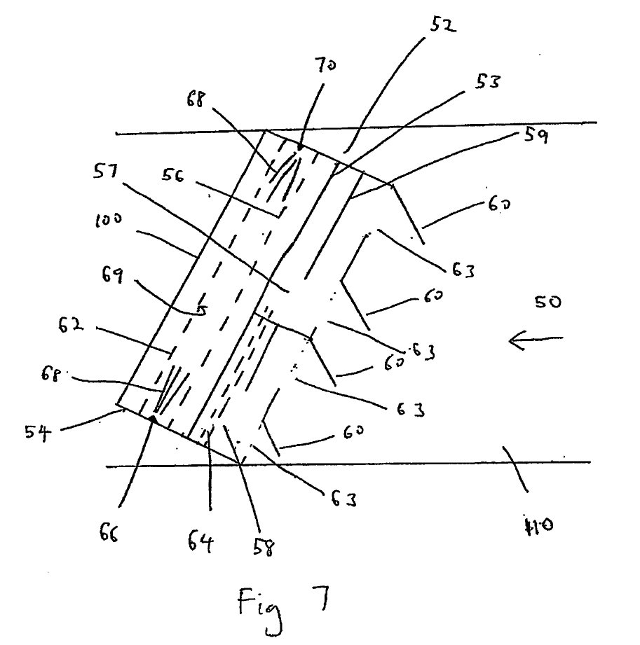

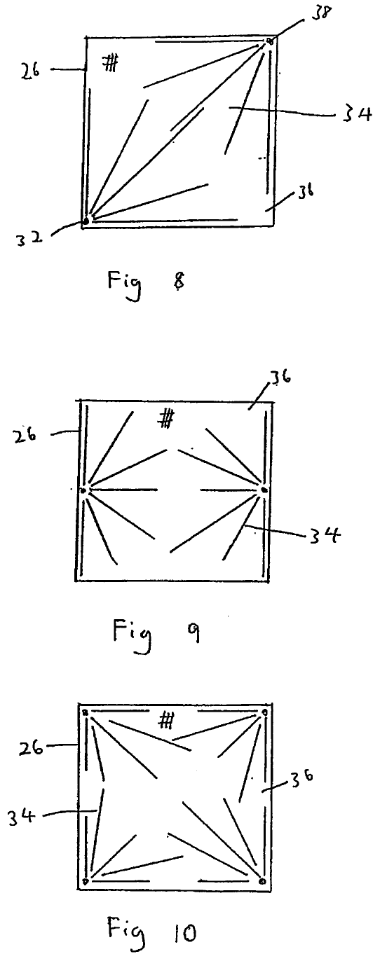

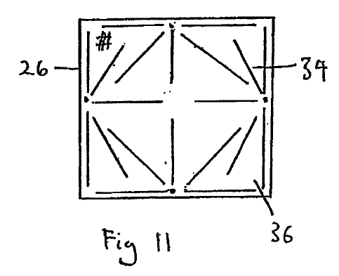

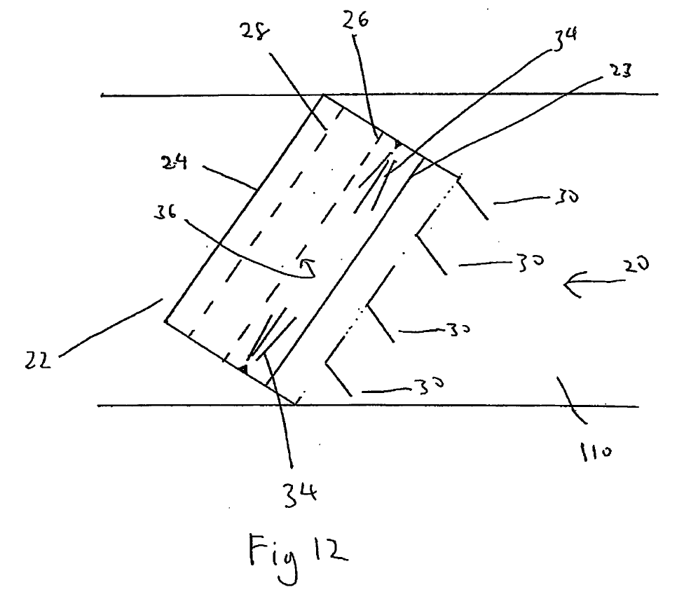

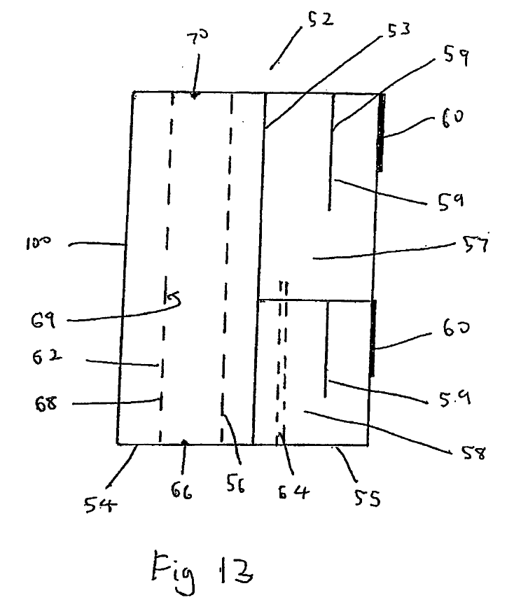

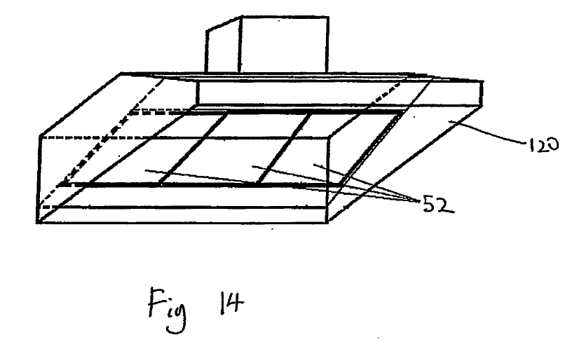

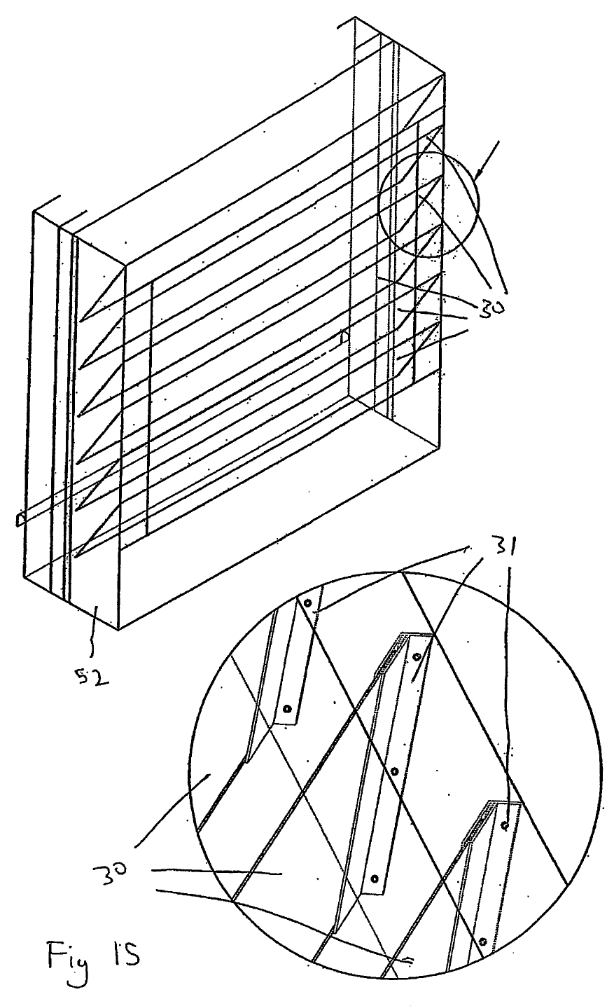

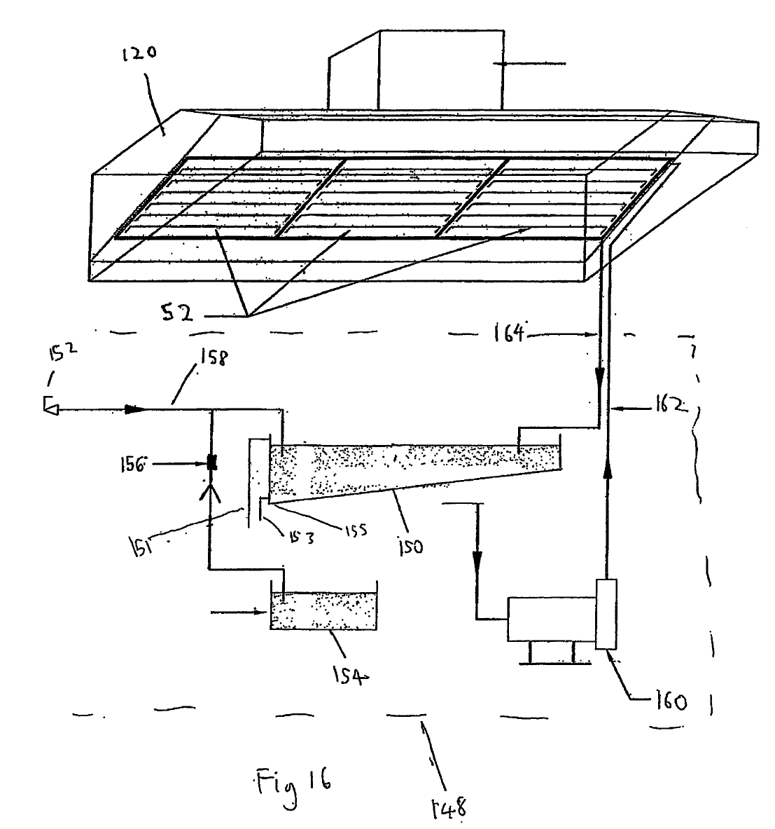

To first refer to FIG. 1, there is shown an airflow path through an exhaust system in which air flows in the direction of arrow 50. The air flowing in the direction of arrow 50 may contain contaminants such as, for example, oil droplets, dust, particulate matter and the like. Air is drawn in the direction of arrow 50 when an exhaust fan (not shown) of the exhaust system is in operation.

A self cleaning filter assembly 52 is mounted in an airflow path in the exhaust system along the direction 50 of airflow. The self cleaning filter assembly may be adaptable to fit braces or slots of existing filter assemblies in existing exhaust systems. Existing baffle filters may be replaced by the self cleaning filter assembly 52. This may enable a conventional kitchen exhaust system to be converted into an advanced grease removal kitchen exhaust system with minimal capital outlay. This is shown in FIG. 14. The self cleaning filter assembly 52 may be fitted in existing braces or slots in an existing exhaust system 120.

The self cleaning filter assembly 52 includes a casing 54. The casing 54 may be a peripheral case bordering close to the internal walls of the pathways of the exhaust system. The filter assembly 52 should substantially block the pathway so that only a minimal volume of air does not pass through the filter assembly 52. A first filter 56 and a second filter 62 are located within the casing 54 in the path of airflow for filtering contaminants such as, for example, oil droplets, dust, particulate matter and the like, from the air flowing in direction 50.

Self-cleaning may mean that cleaning is not complete. It may denote partial cleaning as well. However, there shall be some degree of cleansing involved.

Located before a first end 53 of the casing 54 is an additional fixture 55 comprising a first chamber 57, a second chamber 58, baffles 59, and an adjustable set of louvres 60. The louvres 60 may be activated when the exhaust fan is in operation. The louvres 60 may also be activated when there is sufficiently fast air flow. The fixture 55 may be attached to the casing 54 or may be attached to the internal walls of the pathways of the exhaust system. FIG. 1 shows the instance when the exhaust fan may be operational and the louvres 60 are in an “open” position. Air is then able to flow into openings 63 created by the open louvres 60. When louvres 60 are in the closed position, openings 63 are also closed. However, the louvres 60 may be non-adjustable and locked in a fixed orientation. As such, openings 63 may always be present. FIG. 13 shows the louvres 60 in a “closed” position.

When the exhaust fan is not operational, cleaning of filters in the filter assembly 52 may still be carried out with the louvres 60 in a “closed” position. The edges of each louvre 60 may be lined with water-tight sealing material such as, for example, silicone, rubber and the like. As such, cleaning solution does not leak from the filter assembly 52 into other portions of the exhaust system and areas to be ventilated. This prevents leakage into areas to be ventilated, such as, for example, kitchens, clean rooms and the like. Besides employing louvres 60, a shutter-door like assembly may be used to allow airflow into the filter assembly 52 and to block cleaning solution from exiting from the filter assembly 52. The first chamber 57 and the second chamber 58 of the fixture 55 may also be employed to contain the cleaning solution with drainage in each chamber being drained by a conduit for fluid 64, such as, for example, a drainage pipe.

Located behind the first filter 56 is a second filter 62 preferably substantially the same as first filter 56, so as to allow for inter-changeability. The mesh size of the second filter 62 may be the same as first filter 56, or may be smaller. The first filter 56 may be a relatively coarse filter while the second filter 62 may be a relatively fine filter. Altematively, the first filter 56 may be relatively fine, and the second filter 62 may be relatively coarse. The baffles 59 in the fixture 55 may aid in retarding the speed of air flow through the filter assembly 52 and to prevent spray 68 from exiting through opening 63, particularly when the exhaust fan is not in operation. Such an arrangement may allow for some contaminants to be removed by the first filter 56, with the second filter 62 used for capturing even smaller contaminants. The first filter 56 may also be used to prevent spray 68 from splashing on baffles 59. In such an arrangement, the risk of clogging both the first filter 56 and the second filter 62 is significantly reduced. The first filter 56 may prevent fluid sprayed from nozzles 66 and 70 from exiting the opening 63 of the filter assembly 52. The second filter 62 may also prevent fluid sprayed from nozzles 66 and 70 from exiting the rear end 100 of the filter assembly 52. This minimises the down-time of the exhaust system and may also lower maintenance costs. The filtration rating and type of each filter may be determined by the type of contaminant to be removed from the air flow.

A cleaning solution basin or tank (not shown) may be operatively connected to the filter assembly 52. The tank may be attachable to the exhaust system or may be incorporated in the exhaust system. If separate, appropriate connections such as by hoses, tubes, pipes, manifolds, and so forth will need to be provided. Located in or adjacent the tank may be a pump for optionally supplying a cleaning solution through pipes, tubes or hoses to a first nozzle 66 located in between the first filter 56 and the second filter 62. Nozzle 66 may be a single nozzle, a plurality of nozzles in an array, an outlet manifold with a plurality of holes (as in a shower rose), a fan jet spray with spray concentrated over a small area, or the like.

The purpose of nozzle 66 is to provide a fine spray 68 of water that may contain cleaning solution into the airflow onto the first filter 56 and onto a front surface 69 of the second filter 62 so that the air flow drawn by the exhaust fan draws the fine spray 68 onto substantially the front surface 69 of the second filter 62. The nozzle 66 “atomizes” the cleaning solution to form a fine spray 68. The nozzle 66 may disperse the cleaning solution over an arc of between sixty and one hundred eighty degrees. Preferably, the nozzle 66 disperses the cleaning solution with an arc of one hundred and ten degrees. A second nozzle 70 may also be located in the filter assembly 52 between the first filter 56 and the second filter 62 for the same purpose as the first nozzle 66.

FIG. 3 shows the front view of the nozzle arrangement as shown in FIGS. 1. The first nozzle 66 and a second nozzle 70 are located in front of front surface 69 of the second filter 62. The second nozzle 70 may be the same as first nozzle 66, or maybe different. The first nozzle 66 and second nozzle 70 each disperse cleaning solution in a fine spray 68 with an arc of ninety degrees, allowing coating of a substantial portion of the front surface 69 of second filter 62 with cleaning solution. Coating the front surface 69 of second filter 62 may improve the adhesive properties of the second filter 62 for capturing contaminants from the airflow 50. FIG. 4 shows an altemative arrangement of two nozzles that each disperse cleaning solution in a fine spray 68 with an arc of one hundred eighty degrees such that a substantial portion of the front surface 69 of second filter 62 is coated with cleaning solution. FIGS. 5 and 6 show alternative arrangements of four nozzles. FIG. 5 shows nozzles that each disperse cleaning solution in a fine spray 68 with an arc of ninety degrees while FIG. 6 shows nozzles that each disperse cleaning solution in a fine spray 68 with an arc of one hundred eighty degrees. A single nozzle may also be sufficient for the task of coating a substantial portion of the front surface 69 of second filter 62 with cleaning solution; as is the deployment of a number of nozzles that are not specifically mentioned in the description. A separate pump may be used for each nozzle or, they may all be connected to a single pump.

Referring to FIG. 7, the spray 68 should have a droplet size such that it will be carried by the airflow onto surface 69 of second filter 69. A pressure of between two to three bars applied to each nozzle may affect the size of each droplet emerging from each nozzle. The pressure may also affect the speed at which each droplet emerges from each nozzle. By having filter assembly 52 in an angled position, any excess spray will tend to be captured in the chambers 57, 58 and drained by the conduit 64 for recycling. The conduit 64 may be a gutter that minimises the pipings required in and around the filter assembly. Consequently, the amount of cleaning solution required is also reduced. However, when louvres 60 are in “closed” position, the pressure of the spray 68 may be greater to force contaminants off the filters 56, 62.

In this way the second filter 62 is cleaned by spray 68. The spray 68 will also combine with the contaminants in the airflow to form larger droplets. Louvres 60 may be coated with polytetrafluoroethylene (PTFE or commercially known as Teflon) for ease of removal of such hardened droplets during maintenance. The louvres 60 may also be devoid of any layer of coating. Hence, the louvres 60 may also aid in the filtration process.

Also, the larger droplets will more likely be captured by second filter 62. When captured by second filter 62, as the oil droplets are still fluid as they have not yet cooled, they will be acted on by the degreaser in the cleaning solution of spray 68, and will thus flow down second filter 62 under the influence of gravity to the bottom of casing 54, and flow through an opening into chambers 57, 58. Oil droplets acted on by the degreaser may form a precipitate and settle in the bottom of a waste tank.

The spray 68 coats a substantial portion of the front surface 69 of the second filter 62, thus enhancing the capturing of contaminants by the second filter 62. Under the influence of the airflow, and the spray 68 simultaneously coats and flushes all surfaces of the second filter 68.

In this way the majority of contaminants and cleaning spray 68 is captured by filters 62, 56. This prevents the majority of contaminants and the cleaning spray passing along subsequent portions of the exhaust system. This prevents damage to duct linings, exhaust fans and other components of the exhaust system.

FIG. 2 shows an alternative embodiment of the present invention. There is shown an airflow path through an exhaust system in which air flows in the direction of arrow 20. The air flowing in the direction of arrow 20 may contain contaminants such as for example, oil droplets, dust, particulate matter and the like. Air is drawn in the direction of arrow 20 when an exhaust fan (not shown) of the exhaust system is in operation.

A self cleaning filter assembly 22 is mounted in an airflow path in the exhaust system along the direction 20 of airflow. The self cleaning filter assembly 22 may be adaptable to fit braces or slots of existing filter assemblies in existing exhaust systems. The self cleaning filter assembly includes a casing 24. The casing 24 may be a peripheral case bordering dose to the internal walls of the pathways of the exhaust system. The filter assembly 22 should substantially block the pathway so that only a minimal volume of air does not pass through the filter assembly 22. A first filter 26 is located within the casing 24 in the path of airflow for filtering contaminants such as, for example, oil droplets, dust, particulate matter and the like, from the air flowing in direction 20.

Located before a first end 23 of the casing 24 is an adjustable set of louvres 30 that are activated when the exhaust fan is in operation. The set of louvres 30 may be attached to the casing 24 or may be attached to the internal walls of the pathways of the exhaust system. FIG. 2 shows the instance when the exhaust fan is operational and the louvres 30 are in an “open” position. The louvres 30 may also be activated when there is sufficiently fast air flow. Air is then able to flow into openings 21 created by the open louvres 30. When the exhaust fan is not operational, cleaning of filters in the filter assembly 22 may still be carried out with the louvres 30 in a “closed” position. The edges of each louvre 30 are also lined with water-tight sealing material such as, for example, silicone, rubber and the like. As such, the cleaning solution does not leak from the filter assembly 22 into other portions of the exhaust system and areas to be ventilated. This prevents leakage into areas to be ventilated, such as, for example, kitchens, clean rooms and the like. Besides employing louvres 30, a shutter-door like assembly may be used to allow airflow into the filter assembly 22 and to block cleaning solution from exiting from the filter assembly 22. However, the louvres 30 may be non-adjustable and locked in a fixed orientation. As such, openings 21 may always be present. FIG. 15 shows a close up of the louvre edges locked in a fixed orientation in fixed receptors 31. Each louvre 30 may be easily removable for replacement, cleaning, or maintenance.

Located behind the first filter 26 is a second filter 28 preferably substantially the same as first filter 26, so as to allow for inter-changeability. Its mesh size may be the same as first filter 26, or may preferably be smaller. The first filter 26 may be a relatively coarse filter while the second filter 28 may be a relatively fine filter. Such an arrangement may allow for the majority of contaminants to be removed by the first filter 26, with the second filter 28 used for capturing even smaller contaminants. In such an arrangement, the risk of clogging both the first filter 26 and the second filter 28 is significantly reduced. This minimises the down-time of the exhaust system and may also lower maintenance costs. The filtration rating and type of each filter may be determined by the type of contaminant to be removed from the air flow.

A cleaning solution basin or tank (not shown) may be operatively connected to the filter assembly 22. The tank may be attachable to the exhaust system or may be incorporated in the exhaust system. If separate, appropriate connections such as by hoses, tubes, pipes, manifolds, and so forth will need to be provided. Located in or adjacent the tank may be a pump for optionally supplying a cleaning solution through pipes, tubes or hoses to a first nozzle 32 located in front of first filter 26. Nozzle 32 may be a single nozzle, a plurality of nozzles in an array, an outlet manifold with a plurality of holes (as in a shower rose), or the like.

The purpose of nozzle 32 is to provide a fine spray 34 of water that may contain cleaning solution into the airflow in front of front surface 36 of first filter 26 so that the air flow drawn by the exhaust fan draws the fine spray 34 onto substantially the complete front surface 36 of the first filter 26. The nozzle 32 “atomizes” the cleaning solution to form a fine spray 34. The nozzle 32 disperses the deaning solution over an arc of between sixty and one hundred eighty degrees. Preferably, the nozzle 32 disperses the cleaning solution with an arc of ninety degrees.

FIG. 8 shows the front view of the nozzle arrangement as shown in FIG. 2. The first nozzle 32 and a second nozzle 38 are located in front of front surface 36 of the first filter 26. The second nozzle 38 may be the same as first nozzle 32, or maybe different. The first nozzle 32 and second nozzle 38 each disperse cleaning solution in a fine spray 34 with an arc of ninety degrees, allowing coating of a substantial portion of the front surface 36 of first filter 26 with cleaning solution. Coating the front surface 36 of first filter 26 may improve the adhesive properties of the first filter 26 for capturing contaminants from the airflow. FIG. 9 shows an alternative arrangement of two nozzles that each disperse cleaning solution in a fine spray 34 with an arc of one hundred eighty degrees such that a substantial portion of the front surface 36 of first filter 26 is coated with cleaning solution. FIGS. 10 and 11 show alternative arrangements of four nozzles. FIG. 10 shows nozzles that each disperse cleaning solution in a fine spray 34 with an arc of ninety degrees while FIG. 11 shows nozzles that each disperse cleaning solution in a fine spray 34 with an arc of one hundred eighty degrees. A single nozzle may also be sufficient for the task of coating a substantial portion of the front surface 36 of first filter 26 with cleaning solution; as is the deployment of a number of nozzles that are not specifically mentioned in the description. A separate pump may be used for each nozzle or, they may all be connected to a single pump.

Referring to FIG. 12, the spray 34 should have a droplet size such that it will be carried by the airflow onto surface 36 of first filter 26. However, the pressure applied to each nozzle should preferably not so great that spray 34 will be reflected off surface 36 with such force that it will be flow against the airflow and thus risk passing along the airpath into other portions of the exhaust system. By having filter assembly 22 in an angled position, any reflected spray will tend to be captured by the airflow and directed onto surface 36 of first filter 26. The airflow is being used to assist the fine spray 34 onto surface 36 of first filter 26, However, when louvres 30 are in “closed” position, the pressure of the spray 34 may be greater to force contaminants off the filter 26.

The cleaning solution may be water or, preferably, the cleaning solution is a mixture of water and a degreaser in a required ratio. The ratio may be any suitable ratio depending on the degreaser used, and the type of contaminant being filtered. For example, filtration of cooking fumes and chemical fumes would require different constituent percentage parts of the cleaning solution. Preferably the ratio is in the range of 1:10 to 1:50; more preferably 1:20. For example, if the contaminants are acidic the cleaning solution may be alkaline to not only capture and clean, but also to neutralize the contaminants. Similarly, for alkaline contaminants, the cleaning solution may be acidic. For gaseous contaminants, the cleaning solution may contain neutralizng solutions and/or gases.

In this way the first filter 26 is cleaned by spray 34. The spray 34 will also combine with the contaminants in the airflow to form larger droplets. The larger droplets will tend to fall from the airflow before contacting first filter 26 and will drop under the influence of gravity to the bottom of a pathway 110. The larger droplets may also adhere to the surfaces of louvres 30. Louvres 30 may be coated with polytetrafluoroethylene (PTFE or commercially known as Teflon) for ease of removal of such hardened droplets during maintenance. Hence, the louvres 30 may also aid in the filtration process.

Also, the larger droplets will more likely be captured by first filter 26. When captured by first filter 26, as the oil droplets are still fluid as they have not yet cooled, they will be acted on by the degreaser in the cleaning solution of spray 34, and will thus flow down first filter 26 under the influence of gravity to the bottom of casing 24, and flow through an opening into a waste tank in the exhaust system. In this way the cleaning solution may be recycled as oil droplets in the waste tank will rise to the top facilitating separation of the cleaning solution while the oil may be collected for disposal or recycling.

The spray 34 coats a substantial portion of the front surface 36 of the first filter 26, thus enhancing the capturing of contaminants by the first filter 26. By having the spray 34 in front of the first filter 26, the spray 34 is continuously drawn to, into, and through the first filter 26 under the influence of the airflow, and thus simultaneously coats and flushes all surfaces of the first filter 26.

Droplets from spray 34, particularly relatively fine droplets, and smaller than usual contaminants may pass through first filter 26. They would then be carried by the airflow to second filter 28. At least one nozzle may also be positioned between the first filter 26 and the second filter 28 to substantially coat a front surface 110 of the second filter 28 with cleaning solution for the identical purpose as first filter 26.

In this way the majority of contaminants and cleaning spray 34 is captured by filters 26, 28. This prevents the majority of contaminants and the cleaning spray passing along subsequent portions of the exhaust system. This prevents damage to duct linings, exhaust fans and other components of the exhaust system.

The louvres 30 may be in the same circuit as the exhaust fan for the airflow such that the louvres 30 are in the “closed” position when the exhaust fan is not operational. Hence, the spraying of cleaning solution will take place even when there is no airflow. In this way the cleaning solution cannot flow to the other parts of the exhaust system and the area to be ventilated. However, the louvres 30 should be able to be independently controlled, if desired. This may be required to enable cleaning of the louvres. The pump may also be in the same circuit as the exhaust fan such that sprays from the at least one nozzle may be drawn towards the filters and will not fall under the influence of gravity.

The louvres 30 may also be operable dependent on the speed of the air flow in pathway 110 in the exhaust system. An anemometer (not shown) may be installed into the pathway 110 of the exhaust system to measure the speed of the air flow such that the louvres 30 may be automatically positioned to the “open” position if the speed of the air flow exceeds a specific amount. Similarly, the louvres 30 may be automatically positioned to the “closed” position if the speed of the air flow is of a negligible value, as this means that there is no activity in the area to be ventilated.

By having filters 26, 28 continuously cleaned during the operation of the exhaust system, clogging is less likely and thus smaller mesh sizes may be used in filters 26, 28 to thus increase the effectiveness of their operation. The risk of fire from dried contaminants is also considerably minimised.

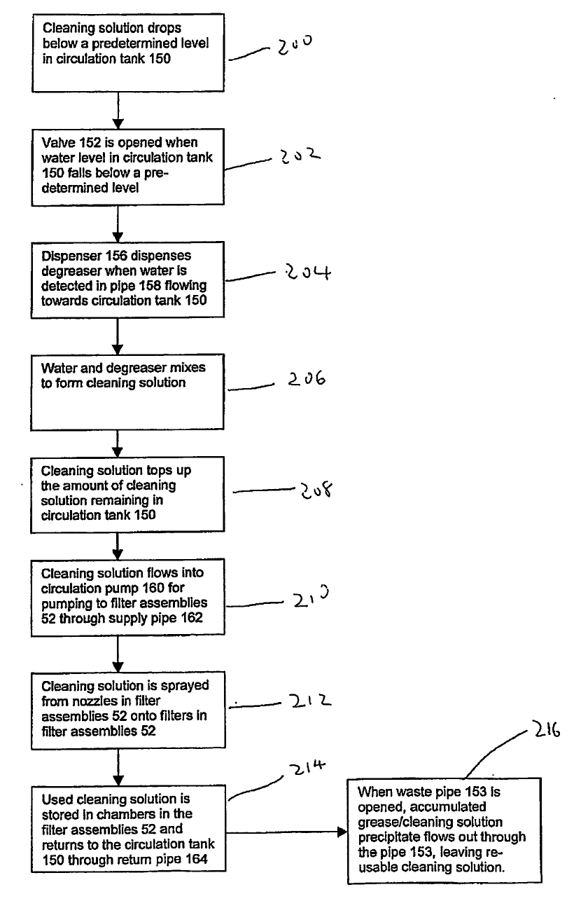

Referring to FIG. 16, there is a cleaning solution circulation system 148 to circulate a degreaser/water cleaning solution in an exhaust hood system 120. There is a circulation tank 150 for the containment of the degreaser/water cleaning solution. When the level of cleaning solution in the circulation tank 150 falls below a pre-determined level, a valve 152 opens and water from an external supply may flow into the circulation tank 150. The valve 152 may be a ball float valve. There is a supplementary tank 154 for the containment of degreaser. There is a dispenser 156 that may dispense degreaser when flow of water towards the circulation tank 150 is detected in a pipe 158. Alternatively, the dispenser 156 may also dispense degreaser when the valve 152 is opened. Preferably the ratio of the degreaser to water is in the range of 1:10 to 1:50; more preferably 1:20.

Conversely, the dispenser 156 may cease dispensing degreaser when the valve 152 is closed. The degreaser and water then mixes in the pipe 158 before draining into circulation tank 150. The valve 152 may be closed once the level of the cleaning solution in circulation tank 150 is filled to a predetermined level.

When the exhaust system 120 is operational, cleaning solution may flow under the influence of gravity from the circulation tank 150 to the plurality of self cleaning filter assemblies 52 through a circulation pump 160. The cleaning solution may be passed through a fine stainless steel wire mesh filter prior to entering the circulation pump 160. As such, damage to the circulation pump 160 from particle clogging is minimised. The circulation pump 160 may operate like a venturi pump. The pump 160 may have a region of reduced cross-sectional area along the flow of the cleaning solution. Due to Bernoulli's principle, the velocity of the flow of the cleaning solution is increased after the region of reduced cross-sectional area. With an increased velocity, the cleaning solution may be propelled against gravity in a supply pipe 162 to the filter assemblies 52. An increased velocity for the flow of the cleaning solution may also increase the velocity of the cleaning solution being spurted from nozzles in the filter assemblies 52. A stream of air may be passed into the cleaning solution either prior or subsequent to the circulation pump 160 such that the pressure in the cleaning solution may be maintained. Aerating the cleaning solution may also aid in cooling the cleaning solution.

After the cleaning solution is sprayed from the nozzles onto filters in the filter assemblies 52, spent deaning solution is accumulated in chambers in each filter assembly 52, before flowing back through a return pipe 164 under the influence of gravity to the circulation tank 150 when a predetermined level in each chamber of each filter assembly 52 is reached.

The mixture of grease and other contaminants with cleaning solution would sink to the bottom of the circulation tank 150 as a precipitate. The circulation tank 150 may have an inclined base such that the precipitate accumulates at the apex 155 of the inclined base of the circulation tank 150. A waste pipe 153 may be opened at a predetermined time to allow the accumulated precipitate to be drained away from the apex 155 of the inclined base of the circulation tank 150.

When the level of the cleaning solution in the circulation tank 150 exceeds a height of a drainage pipe 151, cleaning solution in the tank 150 will flow out till it reaches the height of the drainage pipe 151.

In an alternative embodiment, the circulation system 148 may be positioned above the exhaust system 120. The arrangement of the system 148 would then be to employ a circulation pump 160 where the flow of the cleaning solution goes against the force of gravity.

FIG. 17 shows the process flow for the cleaning solution circulation system 148. When cleaning solution in the circulation tank 150 falls below a predetermined level (200), valve 152 may be automatically opened to allow the flow of water towards the circulation tank 150 (202). Dispenser 156 may automatically dispense degreaser when water flowing towards circulation tank 150 is detected in pipe 158 (204). Water and degreaser then mixes in a preferred proportion to form the cleaning solution (206). The amount of cleaning solution remaining in the circulation tank 150 may then be topped-up with the newly-mixed cleaning solution (208).

When cleaning solution is required in the filter assemblies 52 through supply pipe 162, cleaning solution from the circulation tank 150 may flow into a circulation pump 160 (210). A stream of air may be passed into the cleaning solution either prior or subsequent to the circulation pump 160 such that the pressure in the cleaning solution may be maintained. Aerating the cleaning solution may also aid in cooling the cleaning solution. The cleaning solution may then be sprayed from nozzles in the filter assemblies 52 onto filters in the filter assemblies 52 to maintain the serviceability of the filters (212). Used deaning solution may be stored in chambers in each filter assembly 52 and may flow to the circulation tank 150 through return pipe 164 when the amount of cleaning solution exceeds a pre-determined amount in each chamber (214). Whenever a waste pipe 153 in the circulation tank 150 is opened, precipitate of grease/cleaning solution flows out through the waste pipe 153, thus leaving re-usable cleaning solution for the circulation system 148 (216).

All parts of each self cleaning filter assembly 52 may be dismantled for maintenance. Each self deaning filter assembly 52 may also be retrofitted into existing kitchen hoods of an appropriate size with the use of fasteners such as, for example, nuts and bolts.

Whilst there has been described in the foregoing description preferred embodiments of the present invention, it will be understood by those skilled in the technologies concerned that variations in details of design or construction may be made without departing from the present invention. The present invention extends to all features disclosed either individually, or in all possible combinations and permutations.

1-29. (canceled)

30. A self cleaning filter assembly for use in an exhaust system, comprising:
a duct for positioning about the path of an air flow, the duct housing a first filter and a second filter;
a plurality of spray outlets for dispersion of a liquid within the duct, wherein the plurality of spray outlets form droplets of the liquid sized for combining with a contaminant to form combined droplets in the air flow, and wherein at least one of the first filter and the second filter capture the combined droplets; and
a barrier positioned adjacent the duct to prevent the liquid from dripping from at least one of the first filter and the second filter and out from the duct.

31. A self cleaning filter assembly as claimed in claim 30, wherein the barrier comprises a plurality of louvres that create openings when the exhaust system is operational.

32. A self cleaning filter assembly as claimed in claim 30, wherein the barrier is slidable into the duct to create an opening when the exhaust system is operational.

33. A self cleaning filter assembly as claimed in claim 30, wherein the barrier includes baffles to retard the air flow.

34. A self cleaning filter assembly as claimed in claim 30, wherein the barrier includes at least one chamber for the containment of the liquid.

35. A self cleaning filter assembly as claimed in claim 34, further comprising:
a conduit for fluid drainage of the liquid from the at least one chamber.

36. A self cleaning filter assembly as claimed in claim 30, wherein each spray outlet disperses the liquid in an arc of between sixty degrees and one hundred eighty degrees relative to a central axis of the spray outlet.

37. A self cleaning filter assembly as claimed in claim 30, wherein each spray outlet is selected from a group of outlets consisting of a fan jet spray and a nozzle.

38. A self cleaning filter assembly as claimed in claim 30, wherein the liquid includes water and a degreaser in a ratio in the range of from 1:10 to 1:50.

39. A self cleaning filter assembly as claimed in claim 1, wherein the plurality of spray outlets are on an inlet side of one of the first filter and the second filter.

40. A self cleaning filter assembly as claimed claim 39, wherein the plurality of spray outlets are located at each edge of one of the first filter and the second filter.

41. A self cleaning filter assembly as claimed in claim 30, wherein the plurality of spray outlets are located between the first filter and the second filter.

42. A self cleaning filter assembly as claimed in claim 30, wherein the plurality of spray outlets are located on opposed corners of one of the first filter and the second filter.

43. A self cleaning filter assembly as claimed in claim 30, wherein the plurality of spray outlets are located within the duct.

44. A self cleaning filter assembly as claimed in claim 30, wherein the barrier comprises at least one chamber with at least one baffle therein.

45. A circulation system for fluids into at least one self cleaning filter assembly, comprising:
a circulation tank; and
a circulation pump, wherein the circulation pump operates as a venturi pump to circulate fluids in the system.

46. A circulation system as claimed in claim 45, further comprising:
at least one valve to control the flow of water into the circulation tank.

47. A circulation system as claimed in claim 45, further comprising:
a supplementary tank for the containment of a cleaning fluid.

48. A circulation system as claimed in claim 45, further comprising:
a filter in series with the circulation pump.

49. A circulation system as claimed in claim 45, wherein the circulation tank has an inclined sloping base.
